(19) United States
(12) Patent Application Publication
(10) Pub. No.: US 2014/0240735 A1
(43) Pub. Date: Aug. 28, 2014

(54) SYSTEMS AND METHODS FOR USING A PRINTER DRIVER TO CREATE AND APPLY BARCODES

(71) Applicant: XEROX CORPORATION, Norwalk, CT (US)

(72) Inventor: David L. Salgado, Victor, NY (US)

(73) Assignee: XEROX CORPORATION, Norwalk, CT (US)

(21) Appl. No.: 13/774,001

(22) Filed: Feb. 22, 2013

(51) Int. Cl. G06F 3/12

(52) U.S. Cl. CPC G06F 3/1237
USPC 358/1.13

(57) ABSTRACT

Methods and systems for using a printer driver to create and manage barcodes are provided. The printer driver can apply barcodes to printed copies of documents without modifying the documents in their original form. The printer driver can perform methods that include receiving print data descriptive of a document to be printed, selecting a barcode to be embedded, embedding the barcode in the print data to generate modified print data, generating print commands based on the modified print data, and transmitting the print commands to an output device, where the output device generates a printed copy of the document that includes the barcode. The barcode can include an n-dimensional barcode such as a QR code.

### TECHNICAL FIELD

The subject matter of this disclosure relates to printer drivers. More particularly, the subject matter of this disclosure relates to techniques and platforms for using a printer driver to create, manage, and apply Quick Response codes and other types ofbarcodes in printed documents.

### BACKGROUND

A Quick Response (“QR”) code is a two-dimensional barcode that has gained significant usage in consumer advertising and retail sales, QR codes are commonly printed on a label or displayed on a screen to encode product or service information. Irnformation and advertisement for a product or service can be read by scanning a QR code associated with the product or service, either by using a QR code scanner or a mobile communication device equipped with camera and video recording technology and QR code decoding capability. Such mobile communication devices have become more popular in the consumer marketplace, and many consumers now rely on their mobile communication devices, such as smartphones, to take pictures and shoot videos, obtain information on a product or service of interest, make purchase decisions, conduct financial transactions, and carry out other activities. QR codes provide consumers with the means to quickly and efficiently retrieve a large amount of relevant information, and thus QR codes have been applied to many fields in the consumer world.

Presently, to generate and print a QR code using a computer, a user specifies data to be encoded using a QR code-generating application and instructs the QR code-generating application to generate a QR code that includes the specified data. In response, the QR code-generating application encodes the specified data into a QR code in accordance with a symbology and provides the user with the QR code. The user can either instruct the QR code-generating application to print the QR code or copy-and-paste the QR code into a word processing application for printing. Depending on the user's action, either the QR-generating application or the word processing application generates a print job that includes the QR code and passes, via the computer's operating system (“OS”), the print job to a printer driver installed on the computer. The printer driver is a software program that provides control of a printer and enables the user's computer to communicate with the printer. The printer driver interfaces with the computer's OS and various applications that offer print funmctionality, such as word processors, database management systems, spreadsheets, etc. The printer driver provides a graphical user interface that enables the user to select physical attributes of a print job such as paper size, orientation, paper source, number of copies, etc., as well as graphical attributes such as color, monochrome, halftone, etc. After receiving the print job that includes the QR code from the OS, the printer driver converts the print job into print commands in a format that the printer can understand and checks to see that the printer is online and available to print. The printer driver then sends the print commands to the printer via a connection interface (e.g., parallel, USB, etc.). Printer driver processing of print jobs is the subject of U.S. Pat. No. 6,868,174 titled “Anti-Counterfeit Detection for Low End Products,” which is commonly assigned with the present application to Xerox Corporation and incorporated in its entirety herein by reference.

However, because of the large number of symbologies for encoding data into QR codes and other types of barcodes, few applications support all or most symbologies, and many applications do not directly support any symbology. Thus, users wishing to include QR codes in documents often have to use a specialized QR code-generation application separate from applications they use to create or edit documents. Such reliance on a separate QR code-generation application requires users to modify documents in their original form, either by copying-and-pasting pre-generated QR codes or inserting QR code-generation data strings and commands into the documents. Furthermore, for each document page in which users want QR codes, they would have to separately create or update QR codes and set parameters (e.g., size, data/message, symbology, orientation, location, layout, etc.) for the QR codes. Not only is that process cumbersome and labor-intensive, it can also result in inconsistencies in the size, orientation, location, layout, and other settings of QR codes in the documents.

### SUMMARY

According to various embodiments, the present teachings include a printer driver that can create and manage barcodes, including QR codes and other types of n-dimensional barcodes, and apply the barcodes to printed copies of documents, without modifying the documents in their original form. The printer driver can perform a method that includes receiving print data descriptive of a document to be printed, selecting a barcode to be embedded, embedding the barcode in the print data to generate modified print data, generating print commands based on the modified print data, and transmitting the print commands to an output device, where the output device generates a printed copy of the document that includes the barcode. The barcode can include an n-dimensional barcode such as a QR code.

According to various embodiments, the present teachings include a computer system that uses a printer driver to create and manage barcodes and apply the barcodes to printed copies of documents, without modifying the documents in their original form. The computer system can include a computer processor and a non-transitory memory communicatively coupled to the processor, wherein the processor is configured to receive print data descriptive of a document to be printed, select a barcode to be embedded, embed the barcode in the print data to generate modified print data, generate print commands based on the modified print data, and transmit the print commands to an output device, where the output device generates a printed copy of the document that includes the barcode.

According to various embodiments, the present teachings include a computer program product that can cause a computer to uses a printer driver to create, manage, and apply barcodes. The computer program product can include a non-transitory computer-readable medium storing instructions that, when executed by the computer, cause a computer to use the printer driver to embed one or more barcodes in printed copies of documents, without modifying the documents in their original form. The instructions, when executed by the computer, cause the computer to receive print data descriptive of a document to be printed, select a barcode to be embedded, embed the barcode in the print data to generate modified print data, generate print commands based on the modified print data, and transmit the print commands to an output device, where the output device generates a printed copy of the document that includes the barcode.

It is to be understood that both the foregoing general description and the following detailed description are exemplary and explanatory only and are not restrictive of the invention, as claimed.

The accompanying drawings, which are incorporated in and constitute a part of this specification, illustrate several embodiments of the invention and together with the description, serve to explain the principles of the invention.

### BRIEF DESCRIPTION OF THE DRAWINGS

The accompanying drawings, which are incorporated in and constitute a part of this specification, illustrate embodiments of the invention and together with the description, serve to explain the principles of the invention. In the figures:

FIGS. 1A and 1B illustrate exemplary embodiments of a barcode printing system, in accordance with embodiments of the present teachings;

FIGS. 2 and 3 illustrate flowcharts of processing performed by an exemplary barcode printing system that uses a printer driver to apply and manage barcodes, according to embodiments of the present teachings;

FIGS. 4A and 4B illustrate exemplary graphical user interfaces provided by the printer driver for managing and applying barcodes, according to embodiments of the present teachings; and

FIG. 5 illustrates a computer system that is consistent with embodiments of the present teachings.

### DESCRIPTION OF THE EMBODIMENTS

For simplicity and illustrative purposes, the principles of the present teachings are described by referring mainly to exemplary embodiments thereof. However, one of ordinary skill in the art would readily recognize that the same principles are equally applicable to, and can be implemented in, all types of printing systems, and that any such variations do not depart from the true spirit and scope of the present invention. Moreover, in the following detailed description, references are made to the accompanying figures, which illustrate specific embodiments. Electrical, mechanical, logical and structural changes can be made to the embodiments without departing from the spirit and scope of the present invention. The following detailed description is, therefore, not to be taken in a limiting sense and the scope of the present invention is defined by the appended claims and their equivalents.

Embodiments of the present invention implement a printer driver that enables users to create and manage barcodes and apply barcodes to printed copies of documents, without having to modify original copies of those documents to include graphical or textual representations of the barcodes. Original copies of documents can include electronic copies stored in a computer-readable storage medium, hardcopies fixed in a tangible medium, and the like. Barcodes can include two-dimensional barcodes, lnear brcodes, linear barcodes, and the like. A two-dimensional barcode can include smaller square, rectangular, and/or other shaped elements in a pattern or matrix structured according to a two-dimensional barcode symbology specification, examples of which include Quick Response (“QR”) Code, Aztec Code, Data Matrix, MaxiCode, PDF417, Datastrip, DataGlyphs, High Capacity Color Barcode, and the like. A two-dimensional barcode can also include stacked linear barcodes.

The printer driver can provide a graphical user interface (“GUI”) through which users can create, select, edit, manage, store, and/or apply barcodes. The printer driver can store barcodes, data to be encoded in barcodes, and/or settings or preferences associated with barcodes. When the printer driver receives print data descriptive of a document, such as a print job generated by an application to print the document, the print driver can convert the print data into print commands, generate one or more barcodes, embed or insert the barcodes in the print commands, and send the print commands with the embedded barcodes to a printer.

In various embodiments, the printer driver can instruct a printer to print one or more barcodes on any printed page of a document, independent of the document's content and/or the application used to create, edit, or generate the document. The printer driver allows users to print barcodes on some or all printed pages of a document without having to modify the document in its original form, such as copying-and-pasting pre-generated barcodes or inserting barcode-generation data strings and commands into the original document. Using the printer driver, users can apply one or more barcodes to one or more printed pages of a document. The printer driver can also store barcodes and/or settings and parameters (e.g., name/identifier, type, data/message, symbology, size, orientation, location, layout, color, etc.) associated with the barcodes, thereby allowing users to reuse barcodes and apply barcodes with consistent settings and parameters in different documents and/or different pages within a document. Furthermore, the printer driver can provide users with a common GUI or set of GUIs to create, manage, edit, access, store, and preview barcodes, independent of applications used to create, edit, or generate documents.

Some of the embodiments are described below with respect to a printer driver operating on a computer. However, it will be understood that the described technology may be applied in other environments as well. For example, GUIs described herein may be presented on a printing device, such as a business printer, photocopy machine, multifunction device, and the like. Furthermore, although embodiments below are described with respect to printing of digital documents to paper, it will be understood that those embodiments may be adapted to other environments, such as 3D printing, CNC machining, medical imaging, and so on.

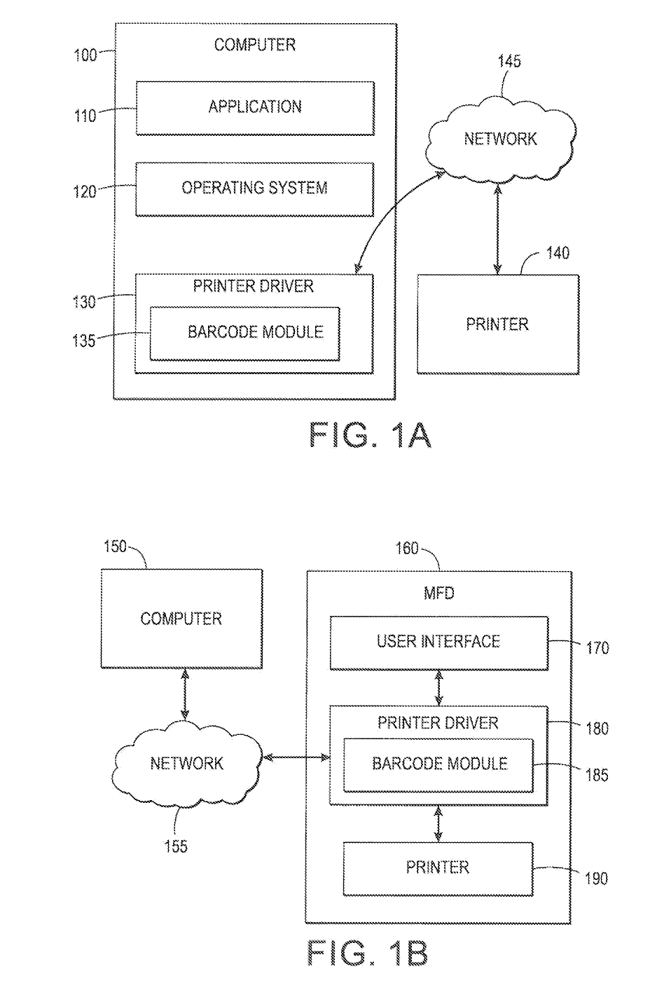

FIGS. 1A and 1B illustrate exemplary embodiments of a barcode printing system consistent with the principles of the present invention. In various embodiments, an example of which is shown in FIG. 1A, the barcode printing system can include a computer 100, Software installed on computer 100 can include one or more applications 110, an operating system (“OS”) 120, and a printer driver 130. Applications 110 can include computer applications, applets, firmware, and other computer programs for manipulating text, graphics, and display data. Applications 110 are managed by OS 120, and can create and edit documents and generate print data (e.g., print jobs) descriptive of the documents. OS 120 can be any commercial, open-source, or proprietary operating system or platform.

As shown in FIG. 1A, printer driver 130 can be a device driver that converts print data generated by applications 110 into print commands in a format that can be interpreted by a printer 140, such as a printer control language, a page description language, a page description markup language, a bitmap, and the like. In various embodiments, printer driver 130 can include a barcode module 135 that enables users of computer 100 to create, manage, customize, access, store, and/or preview QR codes and/or other n-dimensional barcodes. A QR code is encoded based on a two-dimensional barcode symbology that uses a small area of square modules with a unique perimeter pattern, which helps a barcode scanner determine cell locations and decode the QR code. Types of QR codes can include numeric, alphanumeric, byte/binary, Kanji, and the like. QR codes can encode numbers, text, alphabetic characters, Japanese characters, uniform resource locator, control codes, and actual bytes of data, including Unicode characters, biometric features, images, etc. QR codes can be implemented in accordance with the ISO/EC 18004:2006 symbology specification or any other symbology specification known to one skilled in the art. Other types ofn-dimensional barcodes can encode data in accordance with one or more symbologies such as, for example, Aztec Code (ISO/IEC 24778:2008), Data Matrix (ISO/IEC 16022:2006), MaxiCode, PDF417, Datastrip, EAN/UPC, GS1 DataBar Stacked, DataGlyphs, High Capacity Color Barcode, and other symnbology specifications known to one skilled in the art.

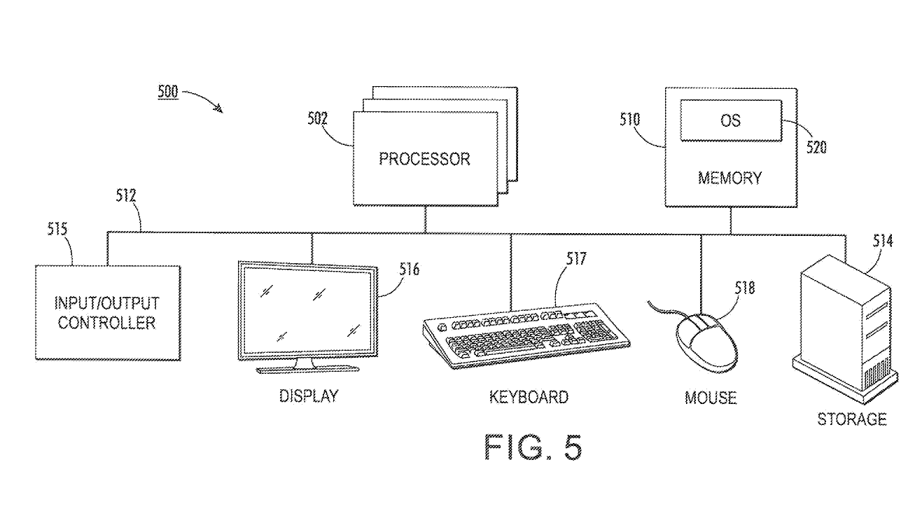

According to various embodiments of the present teachings, computer 100 can be implemented as any type of computer system, such as a server computer, a desktop computer, a virtual machine, a laptop, a mobile device, a tablet computer, a smartphones, a personal digital assistant, and the like. Computer 100 can include components of a conventional computer system, such as components as shown in FIG. 5 and described in greater detail below. In various embodiments, computer 100 in the barcode printing system can be configured to communicate with printer 140 and/or other printers or computer systems. As illustrated in FIG. 1A, for example, printer driver 130 can be implemented to run on computer 100, which is communicatively coupled to printer 140 via a network 145. Network 145 can include one or more communication networks, such as a local area network, a near-field communication link or network, a wide area network, a cellular network, the Internet, a cloud-based network, and the like, or any combination thereof. Printer driver 130 can also communicate and/or interact with a user via network 145. For instance, printer driver 130 can provide one or more GUIs to communicate with the user via network 145, which can include a print dialogue, a web page, a web portal, an electronic mail application, a messaging application, a media player, and other types of network-based interfaces known to one skilled in the art. As such, the user can utilize printer driver 130 running on computer 100 to send print commands to printer 140 via network 145.

Printer driver 130 enables users of computer 100 to print barcodes, including QR codes and/or other n-dimensional barcodes, on one or more pages of a document without having to modify the document in its original form. Subsequent to receiving print data from applications 110 descriptive of a document or pages therein, printer driver 130 can utilize barcode module 135 to insert or embed one or more barcodes in the print data and then convert the print data into print commands. Printer driver 130 can insert or embed the barcodes in the print data independent of applications 110 used to create, edit, or generate the document. Based on user selection, printer driver 130 can apply one or more barcodes to one or more printed pages of a document. For example, printer driver 130 can embed or annotate a barcode onto a printed page (e.g., the first page, the last page, a user-specified page, etc.) or multiple printed pages (e.g., odd or even pages, the first and last pages, multiple user-specified pages, etc.) of a document, Printer driver 130 can also embed or annotate multiple barcodes onto a printed page or multiple printed pages of a document, and can take measures to ensure that the barcodes do not overlap on any of the printed pages.

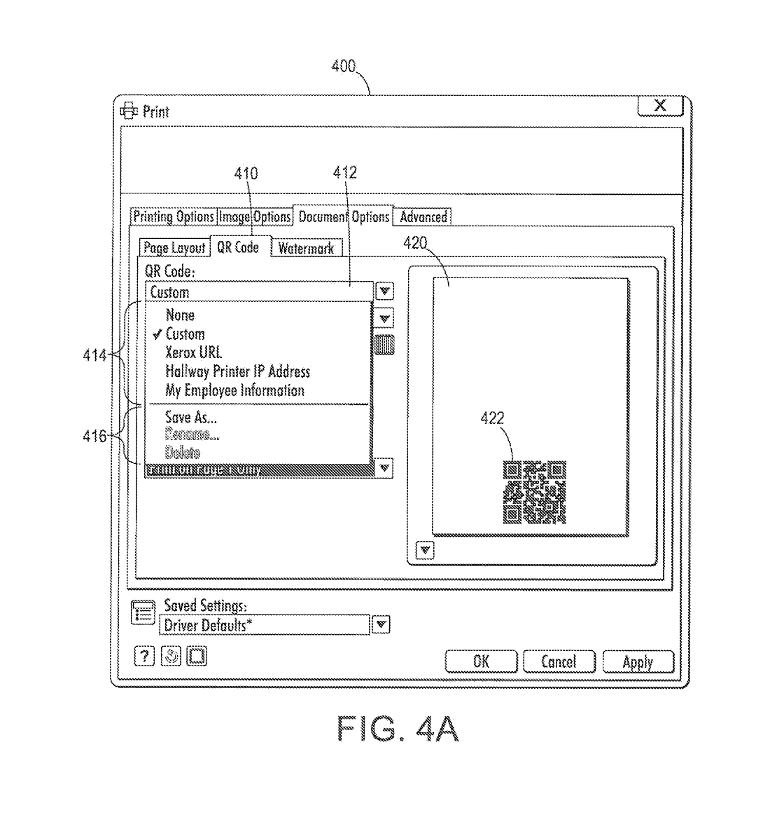

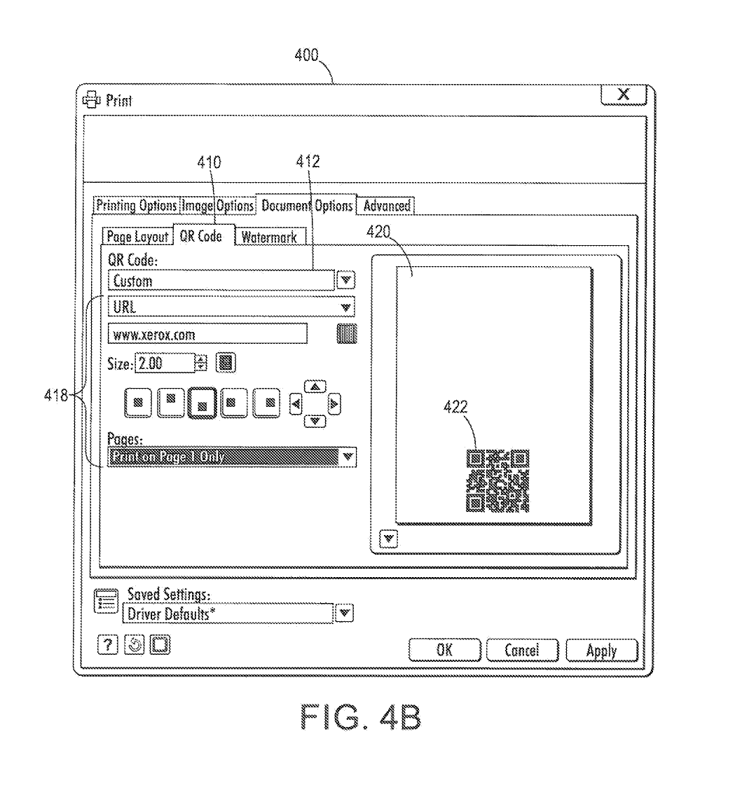

Printer driver 130 can provide one or more GUIs, such as GUI 400 as shown in FIGS. 4A and 413 and described in greater detail below, for users to set and/or modify parameters of barcodes. Properties of a barcode can include its attributes and properties, such as a name or identifier for the barcode, a type of the barcode, data or a message to be encoded in the barcode, a symbology for encoding the barcode, the size, color, and/or style of the barcode, the location, orientation, and/or layout of the barcode with respect to the printed page, and the like. Through the GUIs, printer driver 130 lets users create, apply, manage, access, edit, store, and/or preview barcodes, independent of applications used to create, edit, or generate documents. Printer driver 130 can also let users select and/or print-preview one or more pages on which barcodes are to be applied. Printer driver 130 can store barcodes along with the parameters of the barcodes, thereby allowing users to reuse barcodes and apply barcodes with consistent attributes and properties in different documents and/or different pages within a document.

In various embodiments, an example of which is shown in FIG. 1B, the barcode printing system can include a multifunction device (“MFD”) 160. MFD 160 can include a printer 190, a scanning mechanism (not shown), a fax interface (not shown), etc., and can operate as a printer, a copier, a scanner, a fax machine, and the like. MFD 160 can include a user interface 170, composed of a display and/or input elements. The input elements may include buttons, dials, a touch screen, and the like. MFD 160 can communicate with a computer 150 via a network 155, which can include one or more communication networks, such as a local area network, a near-field communication link or network, a wide area network, a cellular network, the internet, a cloud-based network, and the like, or any combination thereof.

MFD 160 can receive print data descriptive of a document from a component of MFD 160 or computer 150, for example, when a user utilizes MFD 160 to make a copy by scanning a hardcopy of the document or when MFD 160 receives a facsimile of the document from a remote device (e.g., a fax machine or server). MFD 160 can invoke and/or instruct a printer driver 180 to process the print data and modify the print data by embedding one or more barcodes in the print data. MFD 160 can then output a copy of the document with the embedded barcodes based on the modified print data. For example, MFD 160 can instruct printer 190 to print a copy of the document with the embedded barcodes, or MFD 160 can transmit the modified print data to a remote device (e.g., a fax machine or server).

Printer driver 180 can include a barcode module 185, which enables users of MFD 160 to create, manage, customize, access, store, and/or preview barcodes via, for example, user interface 170, computer 150, and/or other means, Printer driver 180 can utilize barcode module 185 to insert or embed one or more barcodes in the print data, convert the print data with the embedded barcodes into print commands, and output the print commands to printer 190 or another output device (e.g., a remote fax machine or server) to generate a printed copy of the document with the embedded barcodes. Based on user selection, printer driver 180 can apply one or more barcodes to one or more printed pages of the document. Printer driver 180 can also apply multiple barcodes to a printed page or multiple printed pages of the document, and can take measures to ensure that the barcodes do not overlap on any of the printed pages.

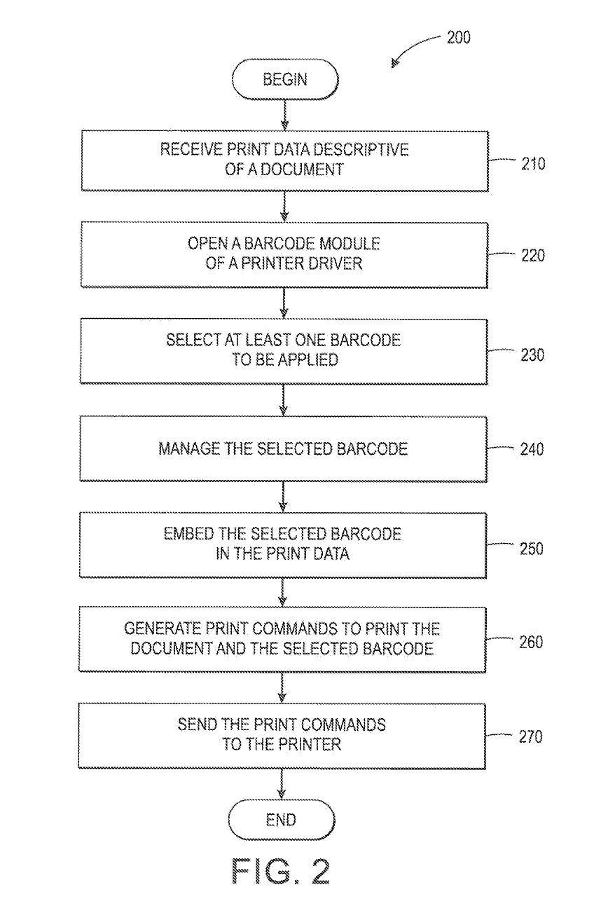

FIG. 2 illustrates a flowchart of processing 200 performed by the barcode printing system to select and apply barcodes, according to embodiments of the present invention. Through processing 200, the barcode printing system can embed or annotate one or more barcodes, such as QR codes and other types of n-dimensional barcodes, in one or more printed pages of a document without modifying the document in its original form. Processing 200 can be performed during the operation of a printer driver (e.g., printer driver 130 or 180) on a user computer (e.g., computer 100) or a multifunction device (e.g., MFD 160). In various embodiments, additional blocks may be included, some blocks may be removed, and/or blocks may be connected or arranged differently from what is shown.

Processing 200 begins at block 210, during which the printer driver in the barcode printing system receives print data descriptive of a document, such as a print job to print or output the document. The printer driver can receive the print data from an application running on a user computer (e.g., computer 100 or 150), from a scanner or a fax interface on a device (e.g., MFD 160), from a network printing client (not shown), or the like. The print data can be formatted in a page description language or otherwise may indicate that it represents a document to be printed. The printer driver can immediately process the received print data, or queue it for later processing. In some embodiments, subsequent to receiving the print data, the printer driver can provide at least one GUI through which a user can create, select, retrieve, edit, store, delete, and/or preview one or more barcodes to be applied to a printed copy of the document, independent of applications used to create, edit, or generate the document.

Next, in block 220, the printer driver can open a barcode module (e.g., barcode module 135 or 185). In some embodiments, the GUI provided by the printer driver includes multiple tabs, and the triggering event of block 220 is the user's selection of an appropriate tab, such as a “QR Code” tab in the GUI. Other user interactions can trigger the activation of the barcode module, such as hovering a cursor over a particular element of the GU, clicking on a portion of the GUI, touching a portion of the GUI via a touch screen, entering certain keystrokes, and so on. Alternatively, the barcode printing system can open the barcode module when the printer driver is opened, initiated, or executed, and thus block 220 is optional in some embodiments.

At block 230, the printer driver can select at least one barcode to apply to a printed copy of the document. The printer driver can provide the GUI through which the user can create a new barcode and/or select an existing barcode. The user can utilize the GUI to select one or more target pages on which barcode are to be applied. For example, the GUI can let the user choose to apply the barcode to a printed page (e.g., the first page, the last page, a user-specified page, etc.) or multiple printed pages (e.g., odd or even pages, the first and last pages, multiple user-specified pages, etc.) of the document.

At block 240, the printer driver can manage the barcode. The printer driver can provide the GUI through which the user can set, view, and/or modify parameters of the barcode, such as a name or identifier for the barcode, a type of the barcode, data or a message to be encoded in the barcode, a symbology fbr encoding the barcode, the size, color, and/or style of the barcode, the location, orientation, and/or layout of the barcode with respect to the printed page, and the like. The printer driver can apply multiple barcodes to a printed page or multiple printed pages of the document, and can take measures to ensure that the barcodes do not overlap on any of the printed pages. Furthermore, the printer driver can store the barcode and/or settings and parameters (e.g., name/identifier, type, data/message, symbology, size, color, location, orientation, layout, etc.) associated with the barcode, thereby allowing the barcode to be reused and/or re-applied with consistent settings and parameters in different pages within the document or in other documents.

At block 250, the printer driver can dynamically generate the barcode and embed or insert the barcode in the print data based on parameters associated with the barcode, thus generating modified print data that includes the barcode. The printer driver can embed or insert the barcode in a portion of the print data descriptive of the one or more selected pages of the document. In some embodiments, the printer driver can utilize the barcode module to embed or insert the barcode. As the user sets and/or modifies the parameters of the barcode, the printer driver can also dynamically regenerate at least one print-preview image, which can include the barcode and can further include at least a portion of the document, and display the print-preview image in the GUI.

At block 260, the printer driver can generate print commands based on the modified print data. Next, at block 270, the printer driver can transmit the print commands with the embedded barcode to an output device, such as a printer (e.g., printer 140 or 190) or a fax machine or server (not shown). In some embodiments, the GUI provided by the printer driver includes one or more buttons, and the triggering event of blocks 260, 270 is the user's selection of an appropriate button, such as a “print” button, a “copy” button, a “fax” button, and the like. The output device can interpret the print commands and output a hardcopy of one or more pages of the document based on the print commands. Finally, subsequent to block 270, processing 200 can end.

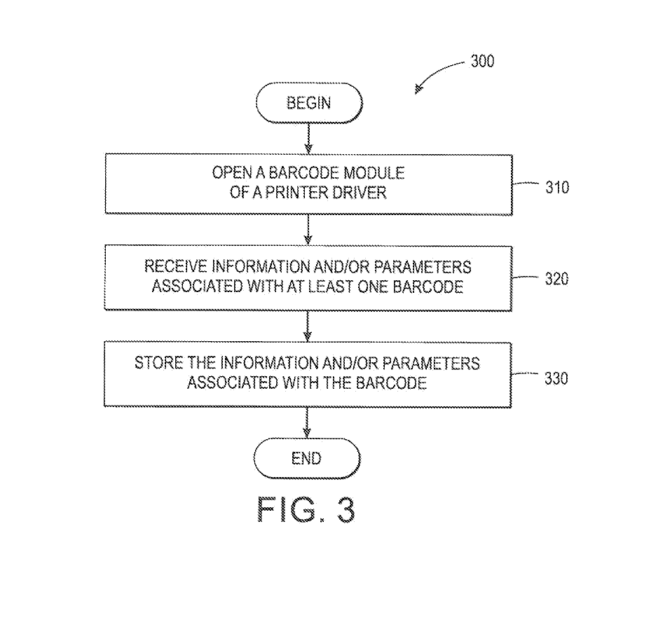

FIG. 3 illustrates a flowchart of processing 300 performed by the barcode printing system to manage barcodes, according to embodiments of the present invention. Through processing 300, the barcode printing system can manage barcodes and allow users to create, retrieve, preview, edit, store, and, or delete barcodes, such as QR codes and other types of n-dimensional barcodes. Processing 300 can be performed during the operation of a printer driver (e.g., printer driver 130 or 180) on a user computer (e.g., computer 100) or a multifunction device (e.g., MFD 160). In various embodiments, additional blocks may be included, some blocks may be removed, and/or blocks may be connected or arranged differently from what is shown.

Processing 300 begins at block 310, during which the printer driver can open a barcode module (e.g., barcode module 135 or 185). In some embodiments, the printer driver can provide at least one GUI that includes multiple tabs, and the triggering event of block 310 is a user's selection of an appropriate tab, such as a “QR Code” tab in the GUI. Other user interactions can trigger the activation of the barcode module, such as hovering a cursor over a particular element of the GUI, clicking on a portion of the GUI, touching a portion of the GUI via a touch screen, entering certain keystrokes, and so on. Alternatively, the barcode printing system can open the barcode module when the printer driver is opened, initiated, or executed, and thus block 310 is optional in some embodiments.

At block 320, the printer driver can receive information and/or parameters associated with at least one barcode. Through the GUI, the user can instruct the printer driver to create a new barcode and/or retrieve an existing barcode. The user can also use the GUI to instruct the printer driver to set, view, and/or modify parameters of the barcode, such as a name or identifier for the barcode, a type of the barcode, data or a message to be encoded in the barcode, a symbology for encoding the barcode, the size, color, and/or style of the barcode, and the like. As the user sets and/or modifies the parameters of the barcode, the printer driver can dynamically render at least one print-preview image representative of the barcode and display the print-preview image in the GUI.

Next, at block 330, the printer driver can store the barcode and/or settings and parameters (e.g., name/identifier, type, data/message, symbology, size, color, location, orientation, layout, etc.) associated with the barcode, thereby allowing the barcode to be reused and/or re-applied with consistent settings and parameters in different documents and/or different pages within a document. Finally, subsequent to block 330, processing 300 can end.

### Sample Graphical User Interfaces

Many different GUI elements may be included for creating, managing, and/or applying barcodes according to methods such as those previously described in accordance with various embodiments. Such elements on several sample GUIs are presented in the following embodiments. It will be understood that individual elements may be used independent of other GUI elements, that GUI elements may be rearranged, and that GUI elements may be added, removed, altered in appearance and/or function, in various embodiments. Although the embodiments presented here relate to GUIs displayed on a windowed operating system using a mouse and/or keyboard as inputs, it will further be understood that aspects of the GUIs may be adapted to many different types of systems, such as touch screen systems, embedded hardware systems, networked systems, and the like, with corresponding adaptations as appropriate for the input and output mechanisms of each system.

FIGS. 4A and 4B illustrate exemplary GUIs through which users can create, retrieve, preview, edit, store, delete, and/or apply barcodes, according to embodiments of the present invention. In various embodiments, a printer driver (e.g., printer driver 130 or 180) running on a user computer (e.g., computer 100) or a multifunction device (e.g., MFD 160) can generate GUI 400 and display GUI 400 on a local user computer (e.g., computer 100), a remote user computer (e.g., computer 150), and/or a user interface (e.g., user interface 170) on the multifunction device.

GUI 400 includes several tabs, among which is a QR code tab 410. In various embodiments, when a tab other than QR code tab 410 is selected, then some or all of the GUI elements shown in FIGS. 4A and 4B can be hidden. Thus, the printer driver can postpone generating and/or displaying GUI elements 412-422 until QR code tab 410 is selected. This can be implemented by setting the selection of QR code tab 410 to be an event that triggers the barcode module, as discussed with respect to block 220 of FIG. 2 and block 310 of FIG. 3, for example. Along similar lines, events that trigger the QR code module can additionally or alternately include initiation or execution of the printer driver, receiving print data from an application, receiving print data from a scanning mechanism or a fax interface, receiving user entry of certain keystrokes, and the like.

As shown in FIG. 4A, user interface 400 can include a drop-down box 412 presenting several options, here relating to QR code selection and management. Drop-down box 412 can include QR code selections 414, such as a “None” selection to apply no QR code, a “Custom” selection to create a new QR code or a set of new QR codes, and zero, one, or multiple QR code selections each corresponding to a stored QR code or a set of stored QR codes. Drop-down box 412 can also include QR code operations 416, such as a “Save As” operation to store a QR code, a “Rename” operation to rename a QR code, and a “Delete” operation to delete a stored QR code.

As shown in FIG. 4B, user interface 400 can include GUI elements 418 for setting and/or modifying parameters associated with a QR code or a set of QR codes. Through GUI elements 418, a user can set and/or modify a type of the QR code, a message or data to be encoded in the QR code, a symbology for encoding the QR code, the size/color/style of the QR code, the location/orientation/layout of the QR code on a printed page, a selection of a page or pages onto which the QR code is to be applied, and the like.

User interface 400 can also include a preview pane 420, which can include a QR code thumbnail 422 that displays the predicted appearance of the QR code on a printed page, based on current parameters and settings associated with the QR code. The preview pane 420 can further include a print-preview of a document or a page therein onto which the QR code is to be applied. As explained with respect to block 250 of FIG. 2 and block 320 of FIG. 3, the printer driver can dynamically regenerate QR code thumbnail 422 when the user creates or selects a QR code and/or when the user sets or modifies parameters associated with the QR code. For example, when the user selects a stored QR code listed in drop-down box 412, the printer driver can dynamically update QR code thumbnail 422 to display a print-preview of the QR code. For another example, when the user uses GUI elements 418 to change the size or the location of a selected QR code, the printer driver can dynamically resize QR code thumbnail 422 or re-locate QR code thumbnail 422 in preview pane 420 to reflect the new size or location of the selected QR code. Similarly, the printer driver can dynamically regenerate QR code thumbnail 422 as the user sets or modifies other parameters associated with the QR code.

### Example Computer System

FIG. 5 illustrates a computer system 500 that is consistent with embodiments of the present teachings. In general, embodiments of a printer driver (e.g., printer driver 130 or 180) in the barcode printing system may be implemented in various computer systems, such as a personal computer, a server, a workstation, an embedded system, a multifunction device, or a combination thereof. Certain embodiments of the printer driver may be embedded as a computer program. The computer program may exist in a variety of forms both active and inactive. For example, the computer program can exist as software program(s) comprised of program instructions in source code, object code, executable code or other formats; firmware program(s); or hardware description language (HDL) files. Any of the above can be embodied on a computer readable medium, which include storage devices and signals, in compressed or uncompressed form. However, for purposes of explanation, system 500 is shown as a general purpose computer that is well known to those skilled in the art. Examples of the components that may be included in system 500 will now be described.

As shown, system 500 may include at least one processor 502, a keyboard 517, a pointing device 518 (e.g., a mouse, a touchpad, and the like), a display 516, main memory 510, an input/output controller 515, and a storage device 514. Storage device 514 can comprise, for example, RAM, ROM, flash memory, EEPROM, CD-ROM or other optical disk storage, magnetic disk storage or other magnetic storage devices, or any other medium that can be used to carry or store desired program code in the form of instructions or data structures and that can be accessed by a computer. A copy of the computer program embodiment of the printer driver can be stored on, for example, storage device 514. System 500 may also be provided with additional input/output devices, such as a printer (not shown). The various components of system 500 communicate through a system bus 512 or similar architecture. In addition, system 500 may include an operating system (OS) 520 that resides in memory 510 during operation. One skilled in the art will recognize that system 500 may include multiple processors 502. For example, system 500 may include multiple copies of the same processor. Alternatively, system 500 may include a heterogeneous mix of various types of processors. For example, system 500 may use one processor as a primary processor and other processors as co-processors. For another example, system 500 may include one or more multi-core processors and one or more single core processors. Thus, system 500 may include any number of execution cores across a set of processors (e.g., processor 502). As to keyboard 517, pointing device 518, and display 516, these components may be implemented using components that are well known to those skilled in the art. One skilled in the art will also recognize that other components and peripherals may be included in system 500.

Main memory 510 serves as a primary storage area of system 500 and holds data that is actively used by applications, such as the printer driver in the barcode printing system, running on processor 502. One skilled in the art will recognize that applications are software programs that each contains a set of computer instructions for instructing system 500 to perform a set of specific tasks during runtime, and that the term “applications” may be used interchangeably with application software, application programs, device drivers, and/or programs in accordance with embodiments of the present teachings. Memory 510 may be implemented as a random access memory or other forms of memory as described below, which are well known to those skilled in the art.

OS 520 is an integrated collection of routines and instructions that are responsible for the direct control and management of hardware in system 500 and system operations. Additionally, OS 520 provides a foundation upon which to run application software and device drivers. For example, OS 520 may perform services, such as resource allocation, scheduling, input/output control, and memory management. OS 520 may be predominantly software, but may also contain partial or complete hardware implementations and firmware. Well known examples of operating systems that are consistent with the principles of the present teachings include MICROSOFT WINDOWS (e.g., WINDOWS CE, WINDOWS NT, WINDOWS 2000, WINDOWS XP, and WINDOWS VISTA), MAC OS, LINUX, UNIX, ORACLE SOLARIS, OPEN VMS, and IBM AIX.

The foregoing description is illustrative, and variations in configuration and implementation may occur to persons skilled in the art. For instance, the various illustrative logics, logical blocks, modules, and circuits described in connection with the embodiments disclosed herein may be implemented or performed with a general purpose processor (e.g., processor 402), a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but, in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

In one or more exemplary embodiments, the functions described may be implemented in hardware, software, firmware, or any combination thereof. For a software implementation, the techniques described herein can be implemented with modules (e.g., procedures, functions, subprograms, programs, routines, subroutines, modules, software packages, classes, and so on) that perform the functions described herein. A module can be coupled to another module or a hardware circuit by passing and/or receiving information, data, arguments, parameters, or memory contents. Information, arguments, parameters, data, or the like can be passed, forwarded, or transmitted using any suitable means including memory sharing, message passing, token passing, network transmission, and the like. The software codes can be stored in memory units and executed by processors. The memory unit can be implemented within the processor or external to the processor, in which case it can be communicatively coupled to the processor via various means as is known in the art.

If implemented in software, the functions may be stored on or transmitted over a computer-readable medium as one or more instructions or code. Computer-readable media includes both tangible, non-transitory computer storage media and communication media including any medium that facilitates transfer of a computer program from one place to another. A storage media may be any available tangible, non-transitory media that can be accessed by a computer. By way of example, and not limitation, such tangible, non-transitory computer-readable media can comprise RAM, ROM, flash memory, EEPROM, CD-ROM or other optical disk storage, magnetic disk storage or other magnetic storage devices, or any other medium that can be used to carry or store desired program code in the form of instructions or data structures and that can be accessed by a computer. Disk and disc, as used herein, includes CD, laser disc, optical disc, DVD, floppy disk and blu-ray disc where disks usually reproduce data magnetically, while discs reproduce data optically with lasers. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Combinations of the above should also be included within the scope of computer-readable media. Resources described as singular or integrated can in one embodiment be plural or distributed, and resources described as multiple or distributed can in embodiments be combined. The scope of the present teachings is accordingly intended to be limited only by the following claims.

Other embodiments of the invention will be apparent to those skilled in the art from consideration of the specification and practice of the invention disclosed herein. It is intended that the specification and examples be considered as exemplary only, with a true scope and spirit of the invention being indicated by the following claims.

What is claimed is:

1. A method of using a printer driver to embed one or more barcodes, the method being performed on a computing system comprising a computer processor and non-transitory storage, the method comprising:
receiving print data descriptive of a document to be printed;
selecting, by a printer driver, a barcode to be embedded;
embedding, by the printer driver, the barcode in the print data to generate modified print data;
generating print commands based on the modified print data; and
transmitting the print commands to an output device, wherein the output device generates a printed copy of the document that includes the barcode.

2. The method of claim 1, wherein the barcode includes a Quick Response code.

3. The method of claim 1, wherein embedding the barcode in the print data by the printer driver further comprises:
embedding the barcode in the print data to generate the modified print data descriptive of the document with the embedded barcode, without modifying the document.

4. The method of claim 1, wherein embedding the barcode in the print data by the printer driver further comprises:
identifying one or more pages of the document; and
embedding the barcode in a portion of the print data descriptive of the one or more pages of the document.

5. The method of claim 4, wherein identifying the one or more pages of the document further comprises:
generating a user interface by the printer driver; and
receiving, via the user interface, input indicative of the one or more pages of the document.

6. The method of claim 1, further comprising:
generating a user interface by the printer driver;
receiving, via the user interface, input indicative of one or more parameters associated with the barcode; and
modifying the barcode based on the one or more parameters.

7. The method of claim 6, wherein the one or more parameters includes at least one of a name of the barcode, a type of the barcode, data to be encoded in the barcode, a symbology for encoding the barcode, a size of the barcode, a color of the barcode, a location of the barcode on a printed page, or an orientation of the barcode relative to a printed page.

8. The method of claim 1, further comprising:
rendering from the modified print data a portion of the document and the barcode to generate a preview image of the portion of the document and the barcode; and
providing the preview image to be displayed.

9. The method of claim 1, wherein selecting the barcode to be embedded further comprises:
generating a user interface by the printer driver; and
receiving, via the user interface, input indicative of a selection of the barcode.

10. The method of claim 1, wherein the print data includes at least one of a print job generated by an application or a scanned image of the document.

11. A computer system that uses a printer driver to embed one or more barcodes comprising:
a computer processor;
a non-transitory memory communicatively coupled to the processor,
wherein the processor is configured to
receive print data descriptive of a document to be printed;
select, by a printer driver, a barcode to be embedded;
embed, by the printer driver, the barcode in the print data to generate modified print data;
generate print commands based on the modified print data; and
transmit the print commands to an output device, wherein the output device generates a printed copy of the document that includes the barcode.

12. The computer system of claim 11, wherein the barcode includes a Quick Response code.

13. The computer system of claim 11, wherein the processor is further configured to:
embed the barcode in the print data to generate the modified print data descriptive of the document with the embedded barcode, without modifying the document.

14. The computer system of claim 11, wherein the processor is further configured to:
identify one or more pages of the document; and
embed the barcode in a portion of the print data descriptive of the one or more pages of the document.

15. The computer system of claim 11, wherein the processor is further configured to:
generate a user interface;
receive, via the user interface, input indicative of one or more parameters associated with the barcode; and
modify the barcode based on the one or more parameters.

16. The computer system of claim 15, wherein the one or more parameters includes at least one of a name of the barcode, a type of the barcode, data to be encoded in the barcode, a symbology for encoding the barcode, a size of the barcode, a color of the barcode, a location of the barcode on a printed page, or an orientation of the barcode relative to a printed page.

17. The computer system of claim 11, wherein the processor is further configured to:
render from the modified print data a portion of the document and the barcode to generate a preview image of the portion of the document and the barcode; and
provide the preview image to be displayed.

18. The computer system of claim 11, wherein the processor is further configured to:
generate a user interface by the printer driver; and
receive, via the user interface, input indicative of a selection of the barcode.

19. The computer system of claim 11, wherein the print data includes at least one of a print job generated by an application or a scanned image of the document.

20. A computer program product, comprising:
a non-transitory computer-readable medium storing instructions that cause a computer to embed one or more barcodes using a printer driver when executed by the computer, comprising:
at least one instruction for causing the computer to receive print data descriptive of a document to be printed;
at least one instruction for causing the computer to select a barcode to be embedded;
at least one instruction for causing the computer to embed the barcode in the print data to generate modified print data;
at least one instruction for causing the computer to generating print commands based on the modified print data; and
at least one instruction for causing the computer to transmit the print commands to an output device, wherein the output device generates a printed copy of the document that includes the barcode.
